(19) United States
(12) Patent Application Publication
(10) Pub. No.: US 2024/0348828 A1
(43) Pub. Date: Oct. 17, 2024

(54) MULTIPLE TRANSFORM SELECTION FOR INTRA BLOCK COPY AND INTRA TEMPLATE MATCHING IN VIDEO CODING

(71) Applicant: QUALCOMM Incorporated, San Diego, CA (US)

(72) Inventors: Patrick Garus, München (DE); Muhammed Zeyd Coban, Carlsbad, CA (US); Bappaditya Ray, San Diego, CA (US); Vadim Seregin, San Diego, CA (US); Marta Karczewicz, San Diego, CA (US)

(21) Appl. No.: 18/631,415

(22) Filed: Apr. 10, 2024

Related U.S. Application Data
(60) Provisional application No. 63/495,976, filed on Apr. 13, 2023.

(51) Int. Cl. H04N 19/61; H04N 19/11; H04N 19/176; H04N 19/593; H04N 19/625; H04N 19/70

(52) U.S. Cl. CPC H04N 19/61; H04N 19/11; H04N 19/176; H04N 19/593; H04N 19/625; H04N 19/70

(57) ABSTRACT

A method of decoding video data includes receiving a block of video data encoded using an intra block copy (IBC) mode or an intra template matching prediction (TMP) mode, determining a pair of transforms, from among a plurality of pairs of transforms, for decoding the block using a multiple transform selection (MTS) process, and decoding the block using the pair of transforms.

This application claims the benefit of U.S. Provisional Patent Application No. 63/495,976, filed Apr. 13, 2023, the entire content of which is incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for video coding. In particular, this disclosure described techniques related to transform coding. This disclosure describes a multiple transform selection (MTS) technique for an Intra Block Copy (IBC) mode as well as an MTS scheme for an Intra Template Matching Prediction (TMP) mode. A video coder may determine one of a plurality of transform pairs to use when coding a block coded with IBC and/or TMP mode. The technique of this disclosure may improve the coding efficiency in the enhanced compression model (ECM) based on Versatile Video Coding (VVC/H.266). The techniques described herein may be used in other advanced video codecs, including extensions of HEVC and the next generation of video coding standards.

In one example, this disclosure describes a method of decoding video data, the method comprising receiving a block of video data encoded using an IBC mode or an intra TMPmode, determining a pair of transforms, from among a plurality of pairs of transforms, for decoding the block using an MTS process, and decoding the block using the pair of transforms.

In another example, this disclosure describes an apparatus configured to decode video data, the apparatus comprising a memory configured to receive a block of video data, and processing circuitry in communication with the memory, the processing circuitry configured to receive the block of video data encoded using an IBC mode or an intra TMP mode, determine a pair of transforms, from among a plurality of pairs of transforms, for decoding the block using a MTS process, and decode the block using the pair of transforms.

In another example, this disclosure describes a method of encoding video data, the method comprising receiving a block of video data to be encoded using an IBC mode or an intra TMP mode, determining a pair of transforms, from among a plurality of pairs of transforms, for decoding the block using a MTS process, and encoding the block using the pair of transforms.

In another example, this disclosure describes an apparatus configured to encode video data, the apparatus comprising a memory configured to receive a block of video data, and processing circuitry in communication with the memory, the processing circuitry configured to receive the block of video data to be encoded using an IBC mode or an intra TMP mode, determine a pair of transforms, from among a plurality of pairs of transforms, for decoding the block using a MTS process, and encode the block using the pair of transforms.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a conceptual diagram illustrating an example of IBC.

FIG. 3 is a conceptual diagram illustrating an example of template matching on a search area around an initial motion vector.

FIG. 4 is a conceptual diagram of an example intra template matching search area.

FIG. 5 is a conceptual diagram illustrating example IBC reference regions depending on a current CU position.

FIG. 6 is a block diagram illustrating an example video encoder that may perform the techniques of this disclosure.

FIG. 7 is a block diagram illustrating an example video decoder that may perform the techniques of this disclosure.

FIG. 8 is a flowchart illustrating an example method for encoding a current block in accordance with the techniques of this disclosure.

FIG. 9 is a flowchart illustrating an example method for decoding a current block in accordance with the techniques of this disclosure.

FIG. 10 is a flowchart illustrating another example method for encoding a current block in accordance with the techniques of this disclosure.

FIG. 11 is a flowchart illustrating another example method for decoding a current block in accordance with the techniques of this disclosure.

### DETAILED DESCRIPTION

Transform coding is a technique used in video coding to compress video data. For example, a video encoder may generate a block of residual values for a block of video data using a prediction process (e.g., inter-prediction). The residual values may then be transformed from the spatial domain to the frequency domain using horizontal and vertical transforms (e.g., a transform pair). Application of such transform pairs produce transform coefficients which generally require fewer bits to represent compared to residual values. The transform coefficients may then be quantized and entropy coded to further compress the data. In some examples, a discrete cosine transform of Type 2 (DCT-2) can be used in video codecs to perform forward and inverse transforms.

In addition to DCT-2 transforms, which has been employed in HEVC, a Multiple Transform Selection (inter-MTS) scheme is used for residual coding for inter coded blocks in other example codecs, such as VVC. In one example, an inter-MTS mode includes the use of multiple selected transforms from a plurality of transform kernels, including DCT of type 8 (DCT-8) and a discrete sine transform of type 7 (DST-7). Both these transform kernels can be applied to both vertical and horizontal transforms, which corresponds to four different possible combinations of transforms.

In some examples, the use of inter-MTS has been restricted to certain coding modes. This disclosure describes techniques for related to transform coding, including an MTS technique for IBC mode and TMP. A video decoder may determine one of a plurality of transform pairs to use when coding a block coded with IBC and/or TMP mode. For example, a video decoder may receive a block of video data encoded using an IBC mode or an intra TMP mode, determine a pair of transforms, from among a plurality of pairs of transforms, for decoding the block using a MTS process, and decode the block using the pair of transforms.

The technique of this disclosure may improve the coding efficiency in the enhanced compression model (ECM) based on Versatile Video Coding (VVC/H.266). The techniques described herein may be used in other advanced video codecs, including extensions of HEVC and the next generation of video coding standards.

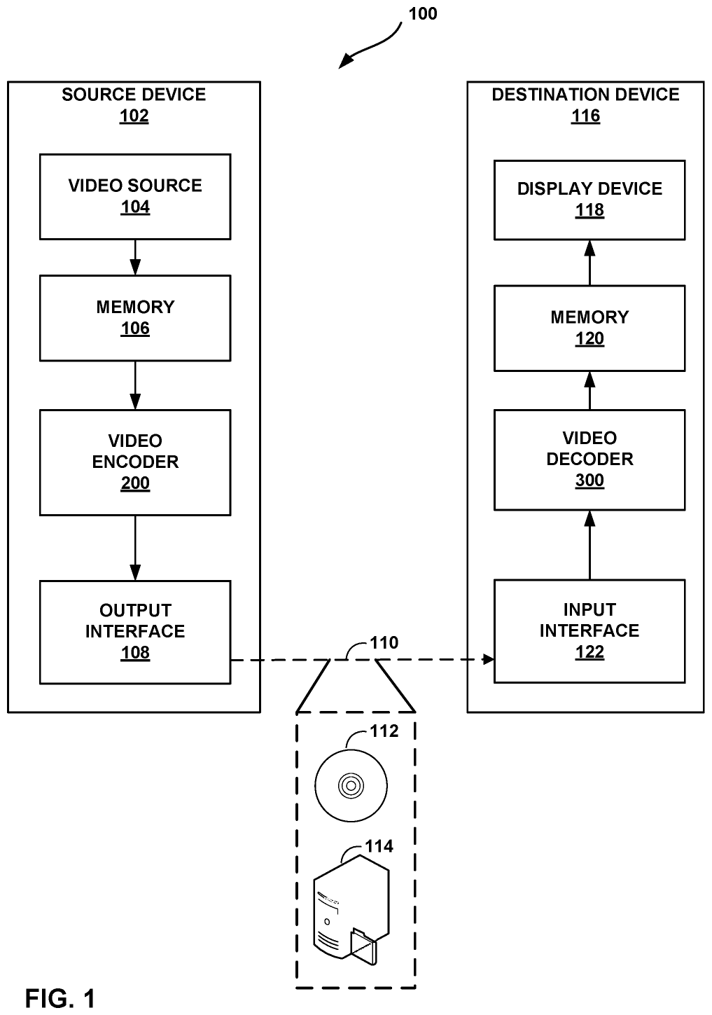

FIG. 1 is a block diagram illustrating an example video encoding and decoding system 100 that may perform the techniques of this disclosure for transform coding. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for transform coding. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for transform coding. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use multiple transform kernels.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary trec partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUS) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In general, this disclosure describes techniques for video coding. In particular, this disclosure described techniques related to transform coding. This disclosure describes a multiple transform selection (MTS) technique for Intra Block Copy (IBC) mode as well as an MTS scheme for Intra Template Matching Prediction (TMP) mode. The technique of this disclosure may improve the coding efficiency in the enhanced compression model (ECM) based on Versatile Video Coding (VVC/H.266). The techniques described herein may be used in other advanced video codecs, including extensions of HEVC and the next generation of video coding standards.

As will be explained in more detail below, video decoder 300 may be configured to receive a block of video data encoded using an IBC mode or an intra TMP mode, determine a pair of transforms, from among a plurality of pairs of transforms, for decoding the block using a MTS process, and decode the block using the pair of transforms.

In a reciprocal fashion, video encoder 200 may be configured to receive a block of video data to be encoded using an IBC mode or an intra TMP mode, determine a pair of transforms, from among a plurality of pairs of transforms, for decoding the block using a MTS process, and encode the block using the pair of transforms.

### Overview of Transform Related Tools

In example video coding standards prior to HEVC, only a fixed separable transform is used where DCT-2 is used both vertically and horizontally. In HEVC, in addition to DCT-2, DST-7 (Type-7 DCT) is also employed for 4×4 blocks as a fixed separable transform. Different combinations of transforms may be considered depending on the block type (e.g., INTRA, INTER or IBC). One technique that is used to consider several transforms for a block is called Multiple Transform Selection (MTS). In MTS, multiple different transform pairs may be tested by video encoder 200 and one of the transform pairs is selected and signaled. Note that MTS was previously called Adaptive Multiple Transforms (AMT). Video encoder 200 indicates the transform pair to be used by signaling an index (in the following denoted as MTSIdx), which is an integer value.

### MTSIdx Signaling

In one version of the ECM, the MTSIdx with values 0 and 1 are considered special cases. For example, MTSIdx=0 indicates DCT-2 transforms are to be used (e.g., both horizontal and vertical DCT-2 transforms), while MTSIdx=1 indicates Transform Skip. That is, the block is coded without a transform.

First, video decoder 300 decodes a transform skip flag (trSkip) which indicates if a transform is applied (e.g., trSkip=true) or not (e.g., trSkip=false). In case of trSkip=false, video decoder 300 further decodes an mts_flag indicating if MTS transforms are used (e.g., mts_flag=true), or not (e.g., mts_flag=false). In case mts_flag=false, DCT-2 transforms are used by video decoder 300. In case mts_flag=true, video decoder 300 decodes the MTSIdx as a truncated binary code. The application of the truncated binary code uses knowledge of the maximum possible number of candidate transform pairs, denoted here as nCands. The value of nCands may be selected adaptively (e.g., for INTRA blocks, including TMP), or may be constant (e.g., for INTER blocks).

In one example of ECM, INTER-Blocks and INTRA-Blocks use the same signaling of the MTSIdx with the index referring to different transform combinations for INTER- (“interMTS”) and INTRA- (“intraMTS”) Blocks. The value of nCands is set to 4 for INTER Blocks. The value of nCands is adaptively set to 1, 4 or 6 (“adaptive intraMTS”) for INTRA Blocks. The IBC Blocks support nothing but DCT-2 and Transform skip, (i.e., in the current ECM, IBC are not coded using MTS).

### Sign Prediction

The sign of transform coefficients can be predicted as part of the sign prediction algorithm. In one example ECM, the prediction area is adaptively extended to 32×32 and the number of predicted signs is configurable.

### IBC Mode

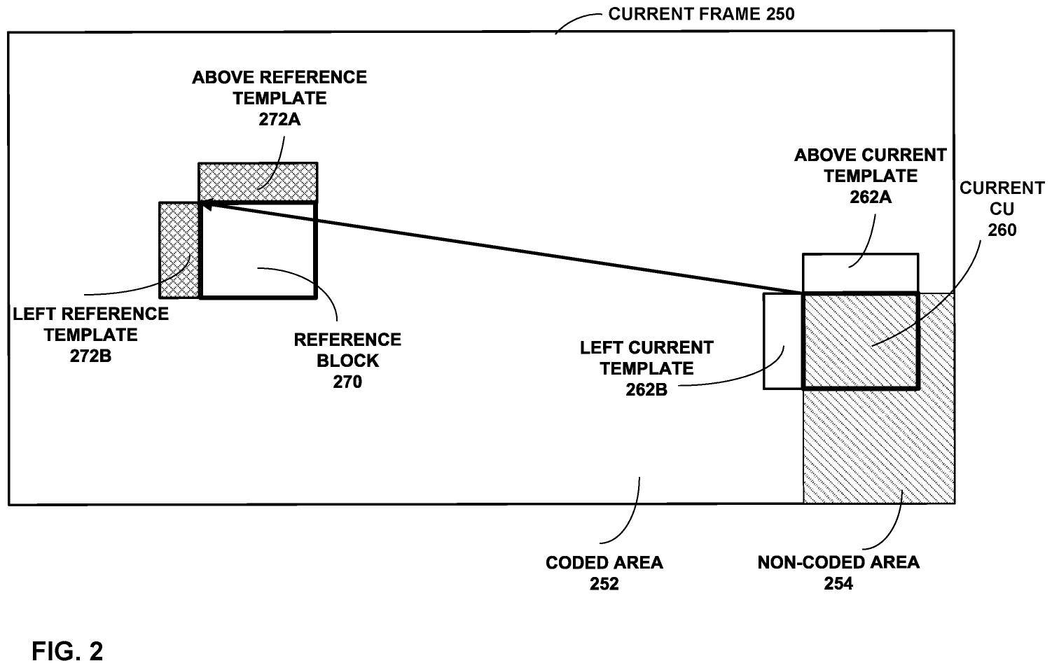

FIG. 2 is a conceptual diagram illustrating an example of Intra Block Copy (IBC) mode. IBC mode is one of the coding tools for screen content. For a current coding unit (CU) 260, a video codec such as video encoder 200 or video decoder 300 using IBC will search a plurality of block vectors and find the best matching block in the reference region for prediction as shown in FIG. 2. Then, a prediction of the chosen block vector is generated and the difference between the chosen block vector and the predicted block vector, known as block vector difference (BVD), is signaled in the bitstream. For example, video encoder 200 may generate the chosen block vector and the BVD and signal the BVD in the bitstream to video decoder 300.

Template matching (TM) is a decoder-side MV derivation technique to refine the motion information of the current CU by finding the closest match between a template (e.g., top and/or left neighboring blocks of the current CU such as above current template 262A and left current template 262B) in the current picture and template (e.g., above reference template 272A and/or left reference template 272B) of a block (e.g., reference block 270) in a reference picture. For example, a closest match may be a closes size match. TM may be applied to both AMVP and regular merge mode, called respectively, TM-AMVP and TM-MRG modes. Similarly, the same TM techniques may also be applied to IBC AMVP and IBC Merge mode. The only difference between Inter TM and IBC TM is that the reference picture for IBC TM is the reconstructed area (coded area 252) in the current frame (current frame 250). As such, the reference block for current CU 260 with IBC TM may be a reference block within coded area 252 (as opposed to non-coded area 254), such as reference block 270. Without loss of generality, this disclosure generally uses “MV” or “motion” to represent that a current CU is an Inter block and has motion information or that the current CU is an IBC block and has block vector information.

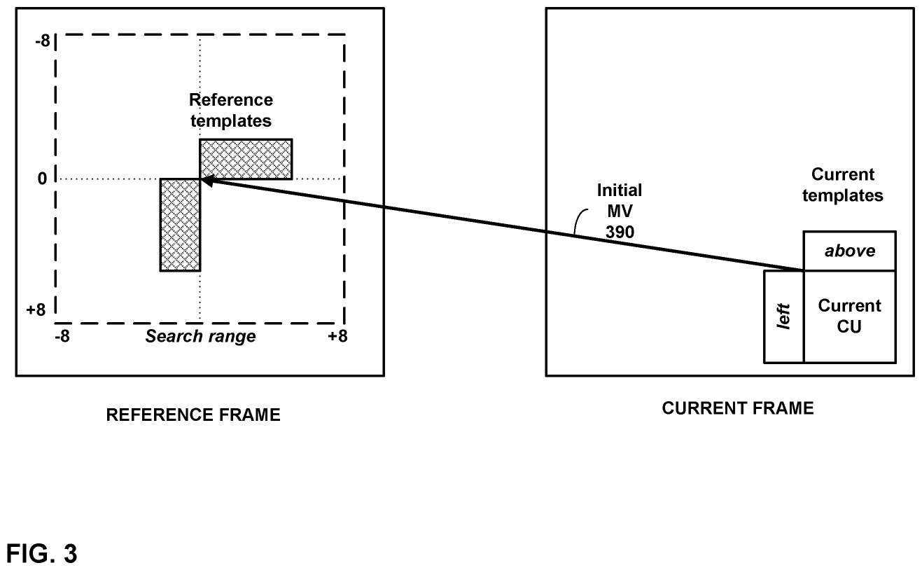

FIG. 3 is a conceptual diagram illustrating an example of template matching on a search area around an initial motion vector. As illustrated in the FIG. 3, a better MV than initial MV 390 is searched around initial MV 390 of the current CU within a [−8, +8]-pel search range. For example, video encoder 200 or video decoder 300 may perform such a search. The template matching techniques in Chen, et al. “Description of SDR, HDR and 360° video coding technology proposal by Qualcomm and Technicolor—low and high complexity versions,” Joint Video Experts Team (JVET) of ITU-T SG 16 WP 3 and ISO/IEC JTC 1/SC 29/WG 11, 10^{th} Meeting: San Diego, 10-20 Apr. 2018, JVET-J0021, may be used with the following modifications: the search step size may be determined based on AMVR mode and TM can be cascaded with a bilateral matching process in merge modes.

Video encoder 200 or video decoder 300 may operate in TM-AMVP mode. In TM-AMVP mode, an MVP candidate is determined based on template matching error to select the one which reaches the minimum difference between the current block template and the reference block template, and then TM may be performed only for this particular MVP candidate for MV refinement. TM may refine this MVP candidate, starting from full-pel MVD precision (or 4-pel for 4-pel AMVR mode) within a [−8, +8]-pel search range by using an iterative diamond search. The AMVP candidate may be further refined by using a cross search with full-pel MVD precision (or 4-pel for 4-pel AMVR mode), followed sequentially by half-pel and quarter-pel cross searches depending on AMVR mode as specified in TABLE 1 below. This search process may ensure that the MVP candidate retains the same MV precision as indicated by the AMVR mode after a TM process. In the search process, if the difference between the previous minimum cost and the current minimum cost in an iteration is less than a threshold that is equal to the area of the block, the search process may terminate.

TABLE 1
SEARCH PATTERNS OF AMVR
AND MERGE MODE WITH AMVR

| | AMVR mode | | | | | |
|---|---|---|---|---|---|---|
| Search | | Full- | Half- | Quarter- | Merge mode | |
| pattern | 4-pel | pel | pel | pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In TM-MRG merge mode, similar search techniques are applied to the merge candidate indicated by the merge index. Video encoder 200 or video decoder 300 may operate in TM-MRG merge mode. As Table 1 shows, TM may perform all the way down to 1/8-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### TMP Mode

Intra template matching prediction (IntraTMP) mode is a special intra prediction mode that in which video encoder 200 or video decoder 300 copies the best prediction block from the reconstructed part of the current frame, whose L-shaped template matches the current template. For a predefined search range, video encoder 200 searches for the most similar template to the current template in a reconstructed part of the current frame and uses the corresponding block as a prediction block. Video encoder 200 then signals the usage of this mode, and the same prediction operation is performed by video decoder 300.

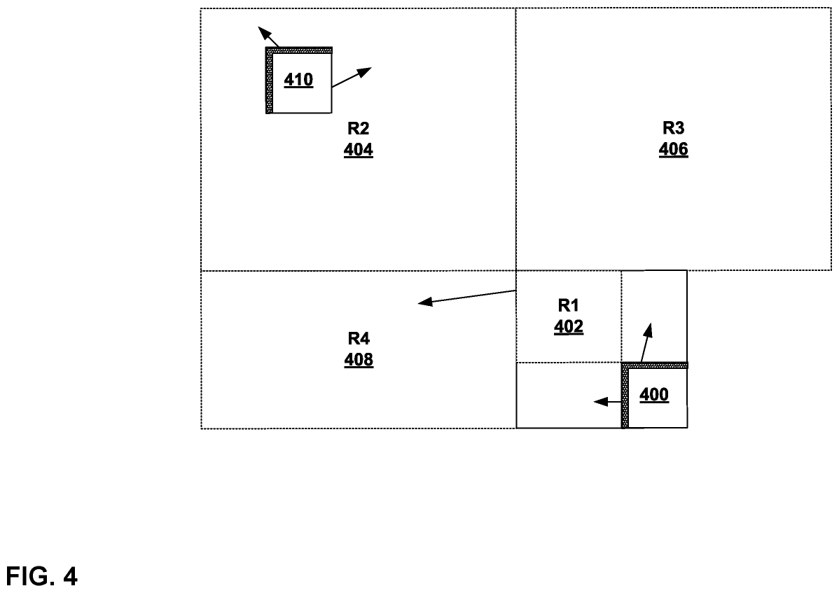

FIG. 4 is a conceptual diagram of an example intra template matching search arca. Video encoder 200 or video decoder 300 may generate a prediction signal. The prediction signal is generated by matching the L-shaped causal neighbor of a current block 400 with another block in a predefined search area in FIG. 4 including R1 402 (the current CTU), R2 404 (the top-left CTU), R3 406 (the above CTU), and R4 408 (the left CTU). SAD may be used as a cost function. Within each region (R1 402, R2 404, R3 406, and R4 408), for example, video decoder 300 searches for the template that has least SAD with respect to the template of current block 400 and uses the corresponding block of the template having the least SAD with respect to the template of current block 400 as a prediction block. For example, video decoder 300 may determine that matching block 410 is the prediction block for current block 400.

The dimensions of all regions (SearchRange_w, SearchRange_h) may be set proportional to the block dimension (BlkW, BlkH) to have a fixed number of SAD comparisons per pixel. That is:

$$SearchRange\_w = 5 * BlkW \\ SearchRange\_h = 5 * BlkH$$

The intra template matching tool may be enabled for CUs with size less than or equal to 64 in width and height. This maximum CU size for intra template matching may be configurable. The intra template matching prediction mode is signaled at a CU level through a dedicated flag when decoder-side intra mode derivation (DIMD) is not used for the current CU.

Template Matching may be used in IBC for both IBC merge mode and IBC AMVP mode, called respectively as IBC-TM-AMVP and IBC-TM-MRG. Video encoder 200 or video decoder 300 may use such modes.

In IBC-TM-MRG, the merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU. In addition, the selected candidates are refined with the Template Matching techniques prior to the RDO or decoding process. The IBC-TM-MRG mode has been put in competition with the regular IBC merge mode and a TM-merge flag is signaled.

In the IBC-TM-AMVP mode, up to 3 candidates are selected from the IBC-TM-MRG merge list. Each of those 3 selected candidates are refined using the Template Matching techniques and sorted according to their resulting Template Matching cost. Only the first 2 candidates are then considered in the motion estimation process.

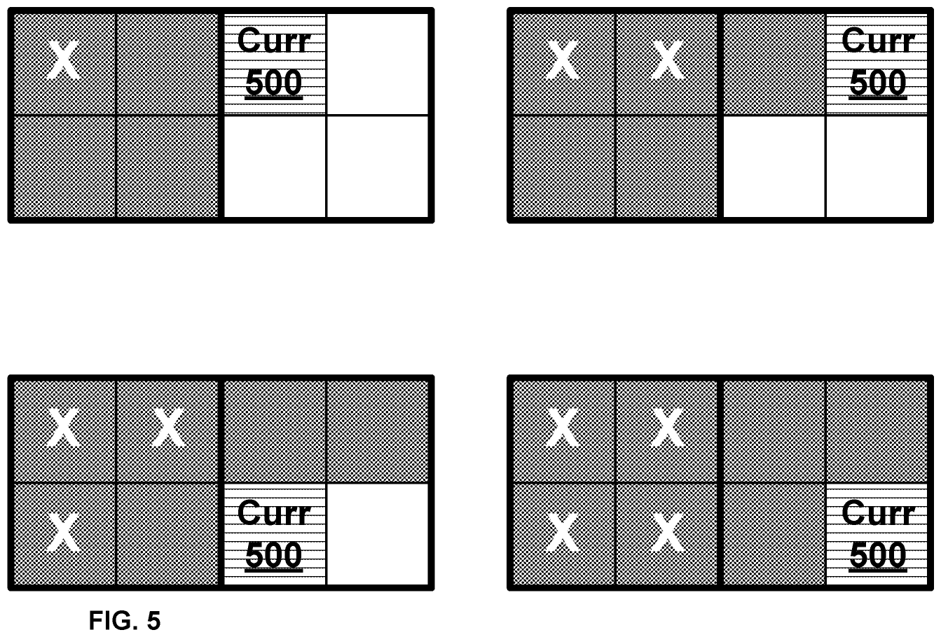

FIG. 5 is a conceptual diagram illustrating example IBC reference regions depending on a current CU position. The Template Matching refinement for both IBC-TM merge and AMVP modes is quite simple since IBC motion vectors are constrained (i) to be integer and (ii) within a reference region as shown FIG. 5. Specifically, in the example of FIG. 5, each small square corresponds to a CU. The squares with darker borders surrounding groups of four CUs may correspond to CTUs. In some examples, each of the CTUs may be of size 128×128 while each of the CUs may have sizes of 64×64. Furthermore, FIG. 5 show a current CU 500 at different locations within a CTU. Shaded CUs are causal for current CU 500. Different CUs are available for IBC depending on the position of current CU 500. In FIG. 5, CUs marked with “X” are unavailable for IBC.

### EXAMPLES

This describes techniques where MTS is used for IBC-Blocks, as well as new techniques for using MTS for INTRA-Blocks using TMP Mode (Intra TMP). Coding efficiency is improved by adding additional transform combinations to be selected for IBC-coded blocks and/or TMP-coded blocks. In some examples, the MTS techniques of this disclosure may improve the coding efficiency of natural content video data when coding such video data using IBC or TMP mode.

Natural content video data refers to video data that captures scenes from the real world, involving real objects, people, landscapes, and animals. This type of video data is typically characterized by its organic, unmanipulated nature, including realistic textures, continuous motion, dynamic range of colors, varied lighting conditions, and depth and perspective. In contrast, screen content video data primarily refers to content generated by computer screens or electronic displays, including text, graphics, and animations. Screen content is typically characterized by high contrast, sharp edges, uniform colors, and often includes static images or text, which are distinct from the more fluid and textured appearance of natural content.

### MTSIdx Decoding Process for IBC Blocks

Video decoder 300 may first decode a transform skip flag is decoded. If the transform skip flag is true (e.g., equals 1), video decoder 300 may apply transform skip to the block. If the transform skip flag is false (e.g., equals 0), video decoder 300 decodes a first bin of the MTSIdx using a context. The first bin of the MTSIdx indicate if DCT-2 is used or not. If the first bin is true, video decoder 300 determines a separable DCT-2 (vertical)/DCT-2 (horizontal) for the IBC-Coded block. If the first bin is false, video decoder 300 may determine the MTS kernel (e.g., the transform pair) is derived by decoding the remaining 2 bins of the MTSIdx, assuming nCands=4 and equal probability (e.g., truncated unary coding). The remaining 2 bins of the decoded MTSIdx={2,3,4,5} (0=DCT, 1=TrSkip) refers to a set of transform combinations used for INTER-Blocks, e.g., interMTS.

If the transform units block width and height are both bigger than 16:
i. MTSIdx=2: DST7/DST7
ii. MTSIdx=3: DCT8/DST7
iii. MTSIdx=4: DST7/DCT8
iv. MTSIdx=5: DCT8/DCT8

If the transform units block width and height are both smaller or equal to 16:
i. MTSIdx=2: KLT0/KLT0
ii. MTSIdx=3: KLT1/KLT0
iii. MTSIdx=4: KLT0/KLT1
iv. MTSIdx=5: KLT1/KLT1.

### Restriction to Certain IBC Modes

In one example, the MTSIdx decoding process described above may be used for certain IBC Modes.

Case 1: MTS is only used for IBC-Blocks encoded using an AMVP Mode. In that case, the condition must hold that for a given IBC-coded Block the merge flag is set to false.

Case 2: MTS is additionally used for IBC-Blocks using AMVP as well as Merge Mode.

### MTS for INTRA Blocks With TMP Mode

For INTRA-coded Blocks using TMP mode, the transform selection is aligned with IBC mode, as described above. Consequently, instead of adaptive intra MTS, interMTS with nCands=4 is used for intra TMP mode.

### Extensions

The MTSIdx decoding process, as well as the selected transforms described above, may be extended while maintaining an alignment between IBC-Coded Blocks and INTRA-Coded Blocks using TMP Mode.

Case 1: Instead of using a constant number of candidate transform pairs where nCands-4, the maximum value of MTSIdx is derived adaptively, e.g., 1, 2 or 4. For example, the number of candidate transform pairs for MTS may be based on a sum of coefficients in the transform block compared to a threshold. The selection of transforms is done from the interMTS kernels described above. If fewer than 4 transform pairs are determined to be used, video encoder 200 and video decoder 300 may truncate the list by discarding the transform pairs later on the lists shown above.

Case 2: Instead of using the interMTS kernels, decoder-side intra mode derivation (DIMD) is introduced for IBC-Coded blocks in order to derive an intra mode index. In that case, intraMTS kernels can be selected either:
a. From the same pre-defined options as for INTRA-coded blocks using intraMTS
b. A separate set of options, different from on the once used for INTRA-coded blocks.

Case 3: Instead of coding the number of candidates or the bins of MTSIdx with equal probability using a truncated unary code, the two bins are each CABAC coded using a dedicated context.

Accordingly, in view of the above, the video decoder 300 may be configured to receive a block of video data encoded using an intra block copy (IBC) mode or an intra template matching prediction (TMP) mode. Video decoder 300 may determine a pair of transforms, from among a plurality of pairs of transforms, for decoding the block using a multiple transform selection (MTS) process, and decode the block using the pair of transforms. In one example, block of video data is encoded using the IBC mode and the IBC mode is an AMVP IBC mode. In another example, the block of video data is encoded using the IBC mode and the IBC mode is an AMVP IBC mode or a merge IBC mode. In any of the above examples, the video data is natural content video data.

To determine the pair of transforms, from among the plurality of pairs of transforms, video decoder 300 is further configured to receive an MTS index, and determine the pair of transforms based on the MTS index (e.g., as described above). In another example, to determine the pair of transforms, from among the plurality of pairs of transforms, video decoder 300 is further configured to receive an MTS index, and determine the pair of transforms based on the MTS index and a size of the block.

The plurality of pairs of transforms may include a vertical type-2 discrete cosine transform (DCT-2) a horizontal DCT-2, and four other pairs of transforms. In other examples, the number of other pairs of transforms may be variable and video decoder 300 may determine the number of the plurality of pairs of transforms. To determine the number of the plurality of pairs of transforms, video decoder 300 may be configured to decode a syntax element indicating the number of the plurality of pairs of transforms using context adaptive binary arithmetic coding and a dedicated context. In another example, to determine the number of the plurality of pairs of transforms, video decoder 300 may be configured to determine an intra mode for the block based on a decoder side intra mode derivation (DIMD) process, and determine the number of the plurality of pairs of transforms based on the intra mode.

Video encoder 200 may perform a reciprocal operation to that of video decoder 300. For example, video encoder 200 may receive a block of video data to be encoded using an IBC mode or an intra TMP mode, determine a pair of transforms, from among a plurality of pairs of transforms, for decoding the block using a MTS process, and encode the block using the pair of transforms. Video encoder 200 may encode an MTS index that indicates the pair of transforms.

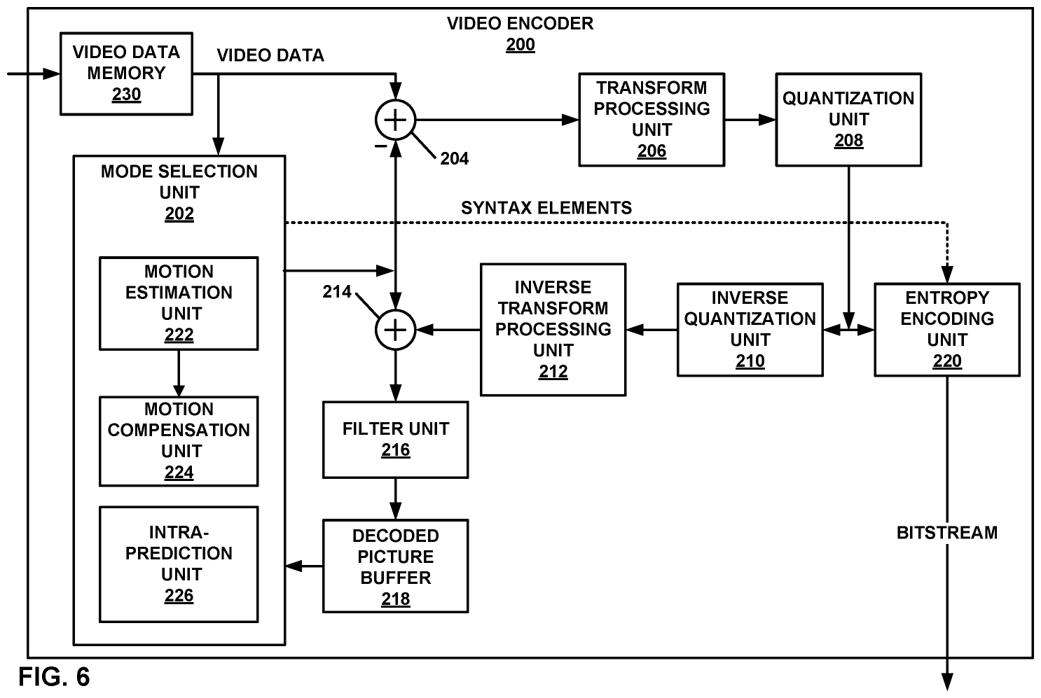

FIG. 6 is a block diagram illustrating an example video encoder 200 that may perform the techniques of this disclosure. FIG. 6 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 6, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 6 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block. Transform processing unit 206 may apply any of the MTS techniques described above when coding a block of video data that was encoded using IBC and/or TMP mode.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Inverse transform processing unit 210 may apply any of the MTS techniques described above when coding a block of video data that was encoded using IBC and/or TMP mode. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to receive a block of video data to be encoded using an IBC mode or an intra TMP mode, determine a pair of transforms, from among a plurality of pairs of transforms, for decoding the block using a MTS process, and encode the block using the pair of transforms.

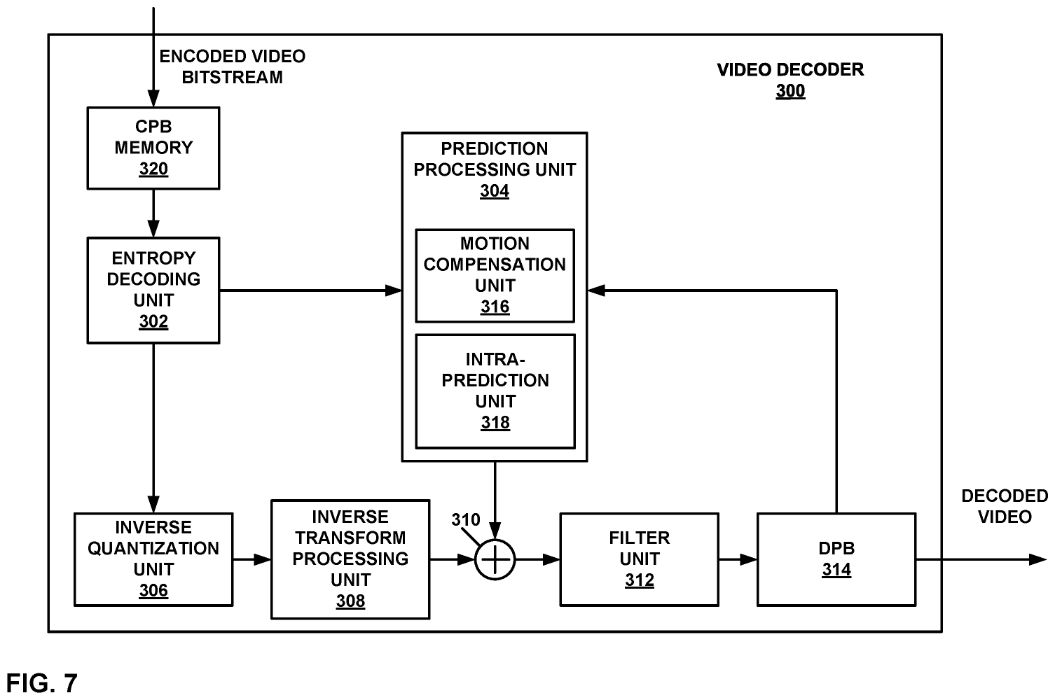

FIG. 7 is a block diagram illustrating an example video decoder 300 that may perform the techniques of this disclosure. FIG. 7 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 7, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 7 are illustrated to assist with understanding the operations performed by video decoder 300. The units may be implemented as fixed-function circuits, programmable circuits, or a combination thereof. Similar to FIG. 6, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block. Inverse transform processing unit 308 may apply any of the MTS techniques described above when coding a block of video data that was encoded using IBC and/or TMP mode.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 6).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 6). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to receive a block of video data encoded using an IBC mode or an intra TMP mode, determine a pair of transforms, from among a plurality of pairs of transforms, for decoding the block using a MTS process, and decode the block using the pair of transforms.

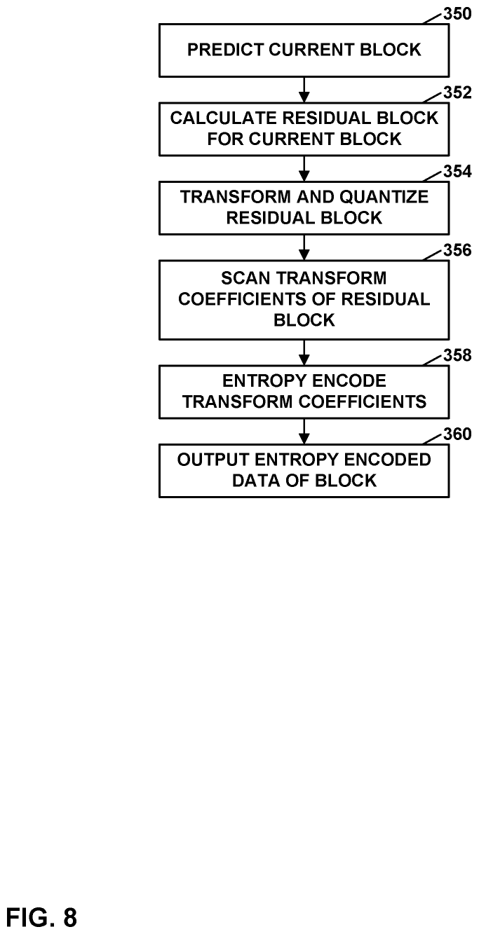

FIG. 8 is a flowchart illustrating an example method for encoding a current block in accordance with the techniques of this disclosure. The current block may be or include a current CU. Although described with respect to video encoder 200 (FIGS. 1 and 6), it should be understood that other devices may be configured to perform a method similar to that of FIG. 8.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

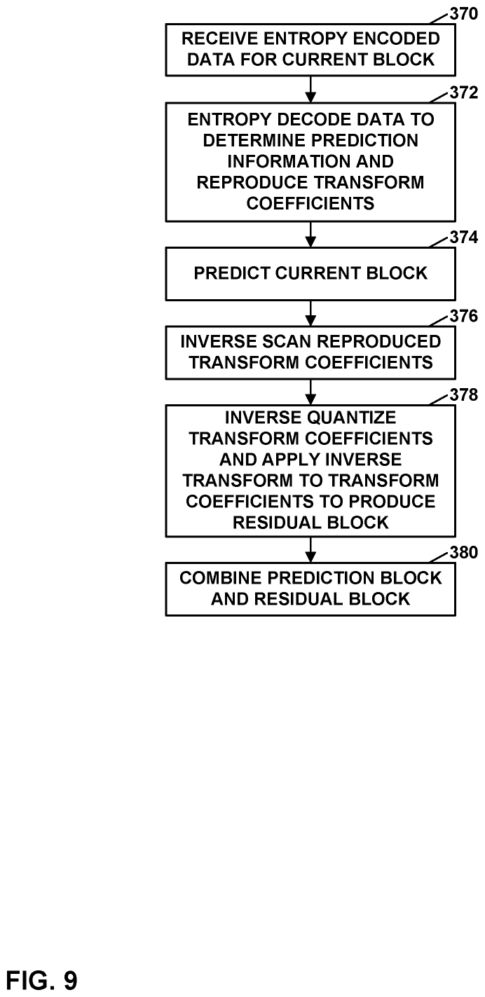

FIG. 9 is a flowchart illustrating an example method for decoding a current block of video data in accordance with the techniques of this disclosure. The current block may be or include a current CU. Although described with respect to video decoder 300 (FIGS. 1 and 7), it should be understood that other devices may be configured to perform a method similar to that of FIG. 9.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

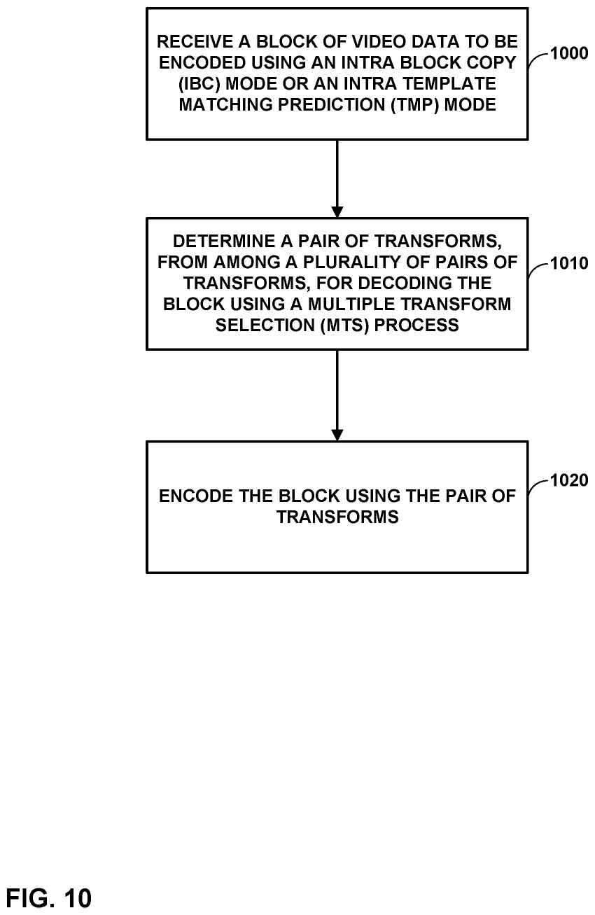

FIG. 10 is a flowchart illustrating another example method for encoding a current block in accordance with the techniques of this disclosure. The techniques of FIG. 10 may be performed by one or more component of video encoder 200, including transform processing unit 206 and/or inverse transform processing unit 212.

In one example of the disclosure, video encoder 200 may be configured to receive a block of video data to be encoded using an intra block copy (IBC) mode or an intra template matching prediction (TMP) mode (1000). In one example, the video data is natural content video data. Video encoder 200 may determine a pair of transforms, from among a plurality of pairs of transforms, for decoding the block using a multiple transform selection (MTS) process (1010), and encode the block using the pair of transforms (1020). The plurality of pairs of transforms may include a vertical type-2 discrete cosine transform (DCT-2) a horizontal DCT-2, and four other pairs of transforms. In one example, video encoder 200 may be may further configured to encode an MTS index that indicates the pair of transforms.

In one example of the disclosure, the block of video data is encoded using the IBC mode and the IBC mode is an AMVP IBC mode. In another example of the disclosure, the block of video data is encoded using the IBC mode and the IBC mode is an AMVP IBC mode or a merge IBC mode.

In another example of the disclosure, video encoder 200 may be further configured to encode a syntax element indicating the number of the plurality of pairs of transforms using context adaptive binary arithmetic coding and a dedicated context. In another example, video encoder 200 may be configured to determine an intra mode for the block based on a decoder side intra mode derivation (DIMD) process, and determine a number of the plurality of pairs of transforms based on the intra mode.

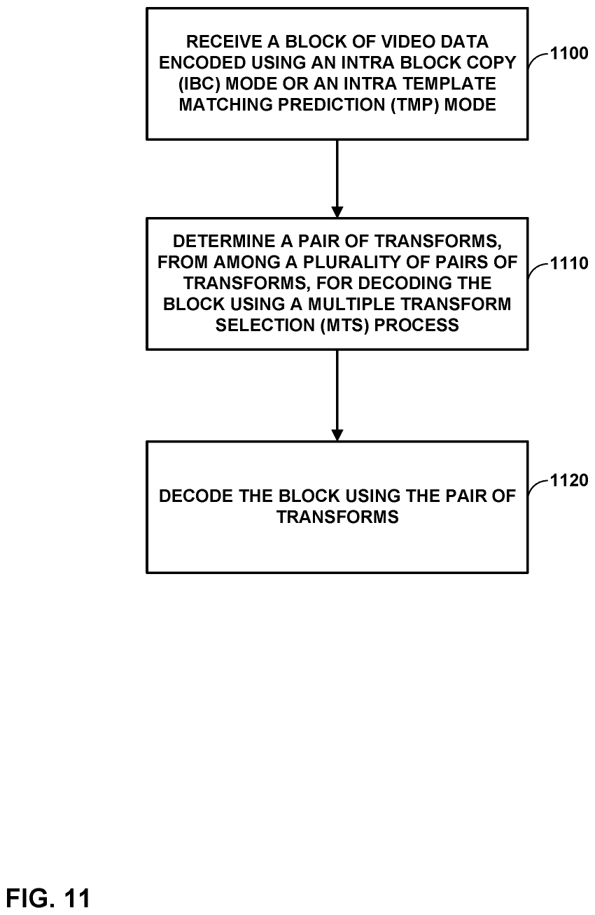

FIG. 11 is a flowchart illustrating another example method for decoding a current block in accordance with the techniques of this disclosure. The techniques of FIG. 11 may be performed by one or more component of video decoder 300, including inverse transform processing unit 308.

In one example of the disclosure, video decoder 300 may be configured to receive the block of video data encoded using an intra block copy (IBC) mode or an intra template matching prediction (TMP) mode (1100). In one example, video data is natural content video data. In one example, the block of video data is encoded using the IBC mode and the IBC mode is an AMVP IBC mode. In another example, the block of video data is encoded using the IBC mode and the IBC mode is an AMVP IBC mode or a merge IBC mode. Video decoder 300 may be further configured to determine a pair of transforms, from among a plurality of pairs of transforms, for decoding the block using a multiple transform selection (MTS) process (1110), and decode the block using the pair of transforms (1120).

In one example, to determine the pair of transforms, from among the plurality of pairs of transforms, video decoder 300 is configured to receive an MTS index, and determine the pair of transforms based on the MTS index. In another example, to determine the pair of transforms, from among the plurality of pairs of transforms, video decoder 300 is configured to receive an MTS index, and determine the pair of transforms based on the MTS index and a size of the block.

In one example, the plurality of pairs of transforms include a vertical type-2 discrete cosine transform (DCT-2) a horizontal DCT-2, and four other pairs of transforms. Video decoder 300 may be further configured to determine a number of the plurality of pairs of transforms. In one example, to determine the number of the plurality of pairs of transforms, video decoder 300 may be configured to decode a syntax element indicating the number of the plurality of pairs of transforms using context adaptive binary arithmetic coding and a dedicated context. In another example, to determine the number of the plurality of pairs of transforms, video decoder 300 is configured to determine an intra mode for the block based on a decoder side intra mode derivation (DIMD) process, and determine the number of the plurality of pairs of transforms based on the intra mode.

The following numbered clauses illustrate one or more aspects of the devices and techniques described in this disclosure.

Aspect 1A. A method of coding video data, the method comprising: determining a transform from among a plurality of transforms for coding a block also coded using an intra block copy mode; and coding the block using the determined transform.

Aspect 2A. The method of Aspect 1A, wherein the intra block copy mode is an AMVP mode.

Aspect 3A. The method of Aspect 1A, wherein the intra block copy mode is an merge mode.

Aspect 4A. A method of coding video data, the method comprising: determining a transform from among a plurality of transforms for coding a block also coded using an intra template matching mode; and coding the block using the determined transform.

Aspect 5A. The method of any of Aspects 1A-4A, wherein coding comprises decoding.

Aspect 6A. The method of any of Aspects 1A-4A, wherein coding comprises encoding.

Aspect 7A. A device for coding video data, the device comprising one or more means for performing the method of any of Aspects 1A-6A.

Aspect 8A. The device of Aspect 7A, wherein the one or more means comprise one or more processors implemented in circuitry.

Aspect 9A. The device of any of Aspects 7A and 8A, further comprising a memory to store the video data.

Aspect 10A. The device of any of Aspects 7A-9A, further comprising a display configured to display decoded video data.

Aspect 11A. The device of any of Aspects 7A-10A, wherein the device comprises one or more of a camera, a computer, a mobile device, a broadcast receiver device, or a set-top box.

Aspect 12A. The device of any of Aspects 7A-11A, wherein the device comprises a video decoder.

Aspect 13A. The device of any of Aspects 7A-12A, wherein the device comprises a video encoder.

Aspect 14A. A computer-readable storage medium having stored thereon instructions that, when executed, cause one or more processors to perform the method of any of Aspects 1A-6A.

Aspect 1B. A method of decoding video data, the method comprising: receiving a block of video data encoded using an intra block copy (IBC) mode or an intra template matching prediction (TMP) mode; determining a pair of transforms, from among a plurality of pairs of transforms, for decoding the block using a multiple transform selection (MTS) process; and decoding the block using the pair of transforms.

Aspect 2B. The method of Aspect 1B, wherein determining the pair of transforms, from among the plurality of pairs of transforms comprises: receiving an MTS index; and determining the pair of transforms based on the MTS index.

Aspect 3B. The method of Aspect 1B, wherein determining the pair of transforms, from among the plurality of pairs of transforms comprises: receiving an MTS index; and determining the pair of transforms based on the MTS index and a size of the block.

Aspect 4B. The method of any of Aspects 1B-3B, wherein the plurality of pairs of transforms include a vertical type-2 discrete cosine transform (DCT-2) a horizontal DCT-2, and four other pairs of transforms.

Aspect 5B. The method of any of Aspects 1B-4B, further comprising: determining a number of the plurality of pairs of transforms.

Aspect 6B. The method of Aspect 5B, wherein determining the number of the plurality of pairs of transforms comprises: decoding a syntax element indicating the number of the plurality of pairs of transforms using context adaptive binary arithmetic coding and a dedicated context.

Aspect 7B. The method of Aspect 5B, wherein determining the number of the plurality of pairs of transforms comprises: determining an intra mode for the block based on a decoder side intra mode derivation (DIMD) process; and determining the number of the plurality of pairs of transforms based on the intra mode.

Aspect 8B. The method of any of Aspects 1B-7B, wherein the block of video data is encoded using the IBC mode and the IBC mode is an AMVP IBC mode.

Aspect 9B. The method of any of Aspects 1B-7B, wherein the block of video data is encoded using the IBC mode and the IBC mode is an AMVP IBC mode or a merge IBC mode.

Aspect 10B. The method of any of Aspects 1B-9B, wherein the video data is natural content video data.

Aspect 11B. An apparatus configured to decode video data, the apparatus comprising: a memory configured to receive a block of video data; and processing circuitry in communication with the memory, the processing circuitry configured to: receive the block of video data encoded using an intra block copy (IBC) mode or an intra template matching prediction (TMP) mode; determine a pair of transforms, from among a plurality of pairs of transforms, for decoding the block using a multiple transform selection (MTS) process; and decode the block using the pair of transforms.

Aspect 12B. The apparatus of Aspect 11B, wherein to determine the pair of transforms, from among the plurality of pairs of transforms, the processing circuitry is further configured to: receive an MTS index; and determine the pair of transforms based on the MTS index.

Aspect 13B. The apparatus of Aspect 11B, wherein to determine the pair of transforms, from among the plurality of pairs of transforms, the processing circuitry is further configured to: receive an MTS index; and determine the pair of transforms based on the MTS index and a size of the block.

Aspect 14B. The apparatus of any of Aspects 11B-13B, wherein the plurality of pairs of transforms include a vertical type-2 discrete cosine transform (DCT-2) a horizontal DCT-2, and four other pairs of transforms.

Aspect 15B. The apparatus of any of Aspects 11B-14B, wherein the processing circuitry is further configured to: determine a number of the plurality of pairs of transforms.

Aspect 16B. The apparatus of Aspect 15B, wherein to determine the number of the plurality of pairs of transforms, the processing circuitry is further configured to: decode a syntax element indicating the number of the plurality of pairs of transforms using context adaptive binary arithmetic coding and a dedicated context.

Aspect 17B. The apparatus of Aspect 15B, wherein to determine the number of the plurality of pairs of transforms, the processing circuitry is further configured to: determine an intra mode for the block based on a decoder side intra mode derivation (DIMD) process; and determine the number of the plurality of pairs of transforms based on the intra mode.

Aspect 18B. The apparatus of any of Aspects 11B-17B, wherein the block of video data is encoded using the IBC mode and the IBC mode is an AMVP IBC mode.

Aspect 19B. The apparatus of any of Aspects 11B-17B, wherein the block of video data is encoded using the IBC mode and the IBC mode is an AMVP IBC mode or a merge IBC mode.

Aspect 20B. The apparatus of any of Aspects 11B-19B, wherein the video data is natural content video data.

Aspect 21B. A method of encoding video data, the method comprising: receiving a block of video data to be encoded using an intra block copy (IBC) mode or an intra template matching prediction (TMP) mode; determining a pair of transforms, from among a plurality of pairs of transforms, for decoding the block using a multiple transform selection (MTS) process; and encoding the block using the pair of transforms.

Aspect 22B. The method of Aspect 21B, further comprising: encoding an MTS index that indicates the pair of transforms.

Aspect 23B. The method of any of Aspects 21B-22B, wherein the block of video data is encoded using the IBC mode and the IBC mode is an AMVP IBC mode.

Aspect 24B. The method of any of Aspects 21B-22B, wherein the block of video data is encoded using the IBC mode and the IBC mode is an AMVP IBC mode or a merge IBC mode.

Aspect 25B. The method of any of Aspects 21B-24B, wherein the video data is natural content video data.

Aspect 26B. An apparatus configured to encode video data, the apparatus comprising: a memory configured to receive a block of video data; and processing circuitry in communication with the memory, the processing circuitry configured to: receive the block of video data to be encoded using an intra block copy (IBC) mode or an intra template matching prediction (TMP) mode; determine a pair of transforms, from among a plurality of pairs of transforms, for decoding the block using a multiple transform selection (MTS) process; and encode the block using the pair of transforms.

Aspect 27B. The apparatus of Aspect 26B, wherein the processing circuitry is further configured to: encode an MTS index that indicates the pair of transforms.

Aspect 28B. The apparatus of any of Aspects 26B-27B, wherein the block of video data is encoded using the IBC mode and the IBC mode is an AMVP IBC mode.

Aspect 29B. The apparatus of any of Aspects 26B-27B, wherein the block of video data is encoded using the IBC mode and the IBC mode is an AMVP IBC mode or a merge IBC mode.

Aspect 30B. The apparatus of any of Aspects 26B-29B, wherein the video data is natural content video data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
receiving a block of video data encoded using an intra block copy (IBC) mode or an intra template matching prediction (TMP) mode;
determining a pair of transforms, from among a plurality of pairs of transforms, for decoding the block using a multiple transform selection (MTS) process; and
decoding the block using the pair of transforms.

2. The method of claim 1, wherein determining the pair of transforms, from among the plurality of pairs of transforms comprises:
receiving an MTS index; and
determining the pair of transforms based on the MTS index.

3. The method of claim 1, wherein determining the pair of transforms, from among the plurality of pairs of transforms comprises:
receiving an MTS index; and
determining the pair of transforms based on the MTS index and a size of the block.

4. The method of claim 1, wherein the plurality of pairs of transforms include a vertical type-2 discrete cosine transform (DCT-2) a horizontal DCT-2, and four other pairs of transforms.

5. The method of claim 1, further comprising:
determining a number of the plurality of pairs of transforms.

6. The method of claim 5, wherein determining the number of the plurality of pairs of transforms comprises:
decoding a syntax element indicating the number of the plurality of pairs of transforms using context adaptive binary arithmetic coding and a dedicated context.

7. The method of claim 5, wherein determining the number of the plurality of pairs of transforms comprises:
determining an intra mode for the block based on a decoder side intra mode derivation (DIMD) process; and
determining the number of the plurality of pairs of transforms based on the intra mode.

8. The method of claim 1, wherein the block of video data is encoded using the IBC mode and the IBC mode is an AMVP IBC mode.

9. The method of claim 1, wherein the block of video data is encoded using the IBC mode and the IBC mode is an AMVP IBC mode or a merge IBC mode.

10. The method of claim 1, wherein the video data is natural content video data.

11. An apparatus configured to decode video data, the apparatus comprising:
a memory configured to receive a block of video data; and
processing circuitry in communication with the memory, the processing circuitry configured to:
receive the block of video data encoded using an intra block copy (IBC) mode or an intra template matching prediction (TMP) mode;
determine a pair of transforms, from among a plurality of pairs of transforms, for decoding the block using a multiple transform selection (MTS) process; and
decode the block using the pair of transforms.

12. The apparatus of claim 11, wherein to determine the pair of transforms, from among the plurality of pairs of transforms, the processing circuitry is further configured to:
receive an MTS index; and
determine the pair of transforms based on the MTS index.

13. The apparatus of claim 11, wherein to determine the pair of transforms, from among the plurality of pairs of transforms, the processing circuitry is further configured to:
receive an MTS index; and
determine the pair of transforms based on the MTS index and a size of the block.

14. The apparatus of claim 11, wherein the plurality of pairs of transforms include a vertical type-2 discrete cosine transform (DCT-2) a horizontal DCT-2, and four other pairs of transforms.

15. The apparatus of claim 11, wherein the processing circuitry is further configured to:
determine a number of the plurality of pairs of transforms.

16. The apparatus of claim 15, wherein to determine the number of the plurality of pairs of transforms, the processing circuitry is further configured to:
decode a syntax element indicating the number of the plurality of pairs of transforms using context adaptive binary arithmetic coding and a dedicated context.

17. The apparatus of claim 15, wherein to determine the number of the plurality of pairs of transforms, the processing circuitry is further configured to:
determine an intra mode for the block based on a decoder side intra mode derivation (DIMD) process; and
determine the number of the plurality of pairs of transforms based on the intra mode.

18. The apparatus of claim 11, wherein the block of video data is encoded using the IBC mode and the IBC mode is an AMVP IBC mode.

19. The apparatus of claim 11, wherein the block of video data is encoded using the IBC mode and the IBC mode is an AMVP IBC mode or a merge IBC mode.

20. The apparatus of claim 11, wherein the video data is natural content video data.

21. A method of encoding video data, the method comprising:
receiving a block of video data to be encoded using an intra block copy (IBC) mode or an intra template matching prediction (TMP) mode;
determining a pair of transforms, from among a plurality of pairs of transforms, for decoding the block using a multiple transform selection (MTS) process; and
encoding the block using the pair of transforms.

22. The method of claim 21, further comprising:
encoding an MTS index that indicates the pair of transforms.

23. The method of claim 21, wherein the block of video data is encoded using the IBC mode and the IBC mode is an AMVP IBC mode.

24. The method of claim 21, wherein the block of video data is encoded using the IBC mode and the IBC mode is an AMVP IBC mode or a merge IBC mode.

25. The method of claim 21, wherein the video data is natural content video data.

26. An apparatus configured to encode video data, the apparatus comprising:
a memory configured to receive a block of video data; and
processing circuitry in communication with the memory, the processing circuitry configured to:
receive the block of video data to be encoded using an intra block copy (IBC) mode or an intra template matching prediction (TMP) mode;
determine a pair of transforms, from among a plurality of pairs of transforms, for decoding the block using a multiple transform selection (MTS) process; and
encode the block using the pair of transforms.

27. The apparatus of claim 26, wherein the processing circuitry is further configured to:
encode an MTS index that indicates the pair of transforms.

28. The apparatus of claim 26, wherein the block of video data is encoded using the IBC mode and the IBC mode is an AMVP IBC mode.

29. The apparatus of claim 26, wherein the block of video data is encoded using the IBC mode and the IBC mode is an AMVP IBC mode or a merge IBC mode.

30. The apparatus of claim 26, wherein the video data is natural content video data.
